(19) United States
(12) Patent Application Publication
(10) Pub. No.: US 2013/0016919 A1
(43) Pub. Date: Jan. 17, 2013

(54) INFORMATION PROCESSING APPARATUS, INFORMATION PROCESSING METHOD, AND PROGRAM

(71) Applicants: Hirofumi Watanabe, Kanagawa (JP); Masato Kajimoto, Chiba (JP); Masashi Kimoto, Tokyo (JP); Masahiro Takahashi, Kanagawa (JP); Seiji Miyama, Kanagawa (JP)

(72) Inventors: Hirofumi Watanabe, Kanagawa (JP); Masato Kajimoto, Chiba (JP); Masashi Kimoto, Tokyo (JP); Masahiro Takahashi, Kanagawa (JP); Seiji Miyama, Kanagawa (JP)

(73) Assignee: SONY CORPORATION, Tokyo (JP)

(21) Appl. No.: 13/536,563

(22) Filed: Jun. 28, 2012

(30) Foreign Application Priority Data
Jul. 12, 2011 (JP) 2011-153659

(51) Int. Cl. G06K 9/36

(52) U.S. Cl. 382/284

(57) ABSTRACT

An information processing apparatus includes an obtaining unit configured to obtain a plurality of partial images obtained by taking images with respect to a subject so that a plurality of image-taking areas are overlapped with each other, a calculation unit configured to determine an area to be used to generate an image of the subject for each of the plurality of partial images obtained and calculate the areas as a plurality of image areas, a generation unit configured to couple the plurality of image areas calculated with each other to generate the subject image, and a synthesis unit configured to synthesize an image that indicates a coupling position of the plurality of image areas in the subject image generated with respect to the subject image.

### CROSS REFERENCES TO RELATED APPLICATIONS

The present application claims priority to Japanese Priority Patent Application JP 2011-153659 filed in the Japan Patent Office on Jul. 12, 2011, the entire content of which is hereby incorporated by reference.

### BACKGROUND

The present disclosure relates to an information processing apparatus, an information processing method, and a program therefore which are capable of generating one image by synthesizing a plurality of images.

In the past, a stitching technique for synthesizing a plurality of partial images obtained by partially taking images of a subject to generate one subject image has been known. The stitching technique is used for a generation of a panorama image, a generation of a scaled-up image with the use of a microscope, or the like. For example, Japanese Patent Application Laid-open No. HEI09-91410 (Hereinafter, referred to as Patent Document 1) discloses a panorama image synthesis system which is intended to appropriately synthesize a plurality of images.

### SUMMARY

However, even if the technique or the like disclosed in Patent Document 1 is used, an error may be caused in positions of a plurality of images synthesized by the stitching technique. In other words, the plurality of images may not be synthesized on appropriate positions and may be synthesized with the images being misaligned. This results in such a failure that a subject is not appropriately displayed on boundaries between the images, for example.

In the fields of medicine, pathology, and the like, a scaled-up image of a cell, a tissue, or the like of a living body which is obtained by an optical microscope is generated by the stitching technique in some cases. At this time, in the case where a cell or the like lies on a boundary between images, the cell or the like may not be appropriately displayed due to the error as described above. As a result, a misdiagnosis may occur when a doctor or the like make a diagnosis with the use of the scaled-up image.

In view of the above-mentioned circumstances, it is desirable to provide an information processing apparatus, an information processing method, and a program which are capable of effectively using a subject image obtained by synthesizing a plurality of partial images in a diagnosis or the like in the field of medicine, for example.

According to an embodiment of the present disclosure, there is provided an information processing apparatus including an obtaining unit, a calculation unit, a generation unit, and a synthesis unit.

The obtaining unit is configured to obtain a plurality of partial images obtained by taking images with respect to a subject so that a plurality of image-taking areas are overlapped with each other.

The calculation unit is configured to determine an area to be used to generate an image of the subject for each of the plurality of partial images obtained and calculate the areas as a plurality of image areas;

The generation unit is configured to couple the plurality of image areas calculated with each other to generate the subject image; and

The synthesis unit is configured to synthesize an image that indicates a coupling position of the plurality of image areas in the subject image generated with respect to the subject image.

In the information processing apparatus, the areas used for the plurality of partial images, respectively, are determined, and those areas are calculated as the plurality of image areas. The plurality of image areas are coupled with each other, thereby generating the subject image. Then, the image that indicates the coupling position of the plurality of images areas in the subject image generated is synthesized with respect to the subject image. Thus, it is possible to grasp the coupling position of the plurality of image areas, on which the subject may not be appropriately displayed. As a result, for a diagnosis or the like in the field of medicine, for example, it is possible to effectively use the subject image obtained by synthesizing the plurality of partial images.

The information processing apparatus may further include an evaluation unit configured to evaluate reproducibility of the subject on the coupling position. In this case, the synthesis unit may synthesize an image on which the reproducibility evaluated is reflected with respect to the subject image.

In the information processing apparatus, the reproducibility of the subject on the coupling position is evaluated, and the image on which the reproducibility evaluated is reflected is synthesized with respect to the subject image. Thus, it is possible to appropriately observe the subject image on the basis of the reproducibility.

The evaluation unit may evaluate, every two image areas coupled with each other out of the plurality of image areas, the reproducibility of the subject on the coupling position of the two image areas.

In this way, every two image areas coupled with each other, the reproducibility of the subject may be evaluated. As a result, it is possible to appropriately observe the subject image.

The plurality of partial images may each have a connection area, which is an area corresponding to a part where the plurality of image-taking areas are overlapped with each other. In this case, the calculation unit may determine an area to be used to generate the subject image by connecting the plurality of partial images with each other with the connection area as a reference. Further, the evaluation unit may evaluate the reproducibility of the subject on the coupling position on the basis of connection accuracy at a time when the plurality of partial images are connected.

In the information processing apparatus, the plurality of partial images are connected with the connection area as a reference, and on the basis of the connection result, the area to be used to generate the subject image is determined. Then, on the basis of the connection accuracy of the plurality of partial images connected, the reproducibility of the subject on the coupling position is evaluated. That is, in this embodiment, it is possible to use the result of the connection process for the reproducibility evaluation of the subject.

The information processing apparatus may further include a connection area image generation unit, an input unit, and an output unit.

The connection area image generation unit is configured to generate an image of the connection area from the partial image.

The input unit is configured to receive an instruction to confirm the subject displayed on the coupling position.

The output unit is configured to output the connection area image generated on the basis of the confirmation instruction received.

In the information processing apparatus, the connection area image corresponding to a part of the partial image is generated. Then, on the basis of the confirmation instruction of the subject displayed on the coupling position, the connection area image is output. On the connection area image, the subject, the image of which is taken, is displayed as it is, so it is possible to confirm the subject.

The information processing apparatus may further include a storage unit, an input unit, and an output unit.

The storage unit is configured to store the plurality of partial image.

The input unit is configured to receive an instruction to confirm the subject displayed on the coupling position.

The output unit is configured to output at least one of the plurality of partial images stored, on the basis of the confirmation instruction received.

In this way, the plurality of partial images are stored, and the partial images may be output on the basis of the confirmation instruction of the subject displayed on the coupling position.

According to another embodiment of the present disclosure, there is provided an information processing method in an information processing apparatus.

In the information processing method, a plurality of partial images obtained by taking images with respect to a subject so that a plurality of image-taking areas are overlapped with each other are obtained.

An area to be used to generate an image of the subject for each of the plurality of partial images obtained is determined, and the areas are calculated as a plurality of image areas.

The plurality of image areas calculated are coupled with each other to generate the subject image.

An image that indicates a coupling position of the plurality of image areas in the subject image generated is synthesized with respect to the subject image.

According to another embodiment of the present disclosure, there is provided a program causing an information processing apparatus to execute an obtaining step, a calculating step, a generating step, and a synthesizing step.

In the obtaining step, a plurality of partial images obtained by taking images with respect to a subject so that a plurality of image-taking areas are overlapped with each other are obtained.

In the calculating step, an area to be used to generate an image of the subject for each of the plurality of partial images obtained is determined, and the areas are calculated as a plurality of image areas.

In the generating step, the plurality of image areas calculated are coupled with each other to generate the subject image.

In the synthesizing step, an image that indicates a coupling position of the plurality of image areas in the subject image generated is synthesized with respect to the subject image.

As described above, according to the present disclosure, it is possible to effectively use the subject image obtained by synthesizing the plurality of partial images in the diagnosis or the like in the field of medicine, for example.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing an image processing system according to a first embodiment of the present disclosure;

FIG. 2 is a schematic diagram showing a structural example of a digital microscope and the information processing apparatus shown in FIG. 1;

FIG. 3 is a block diagram showing a hardware structure of the information processing apparatus shown in FIG. 1;

FIG. 4 is a schematic diagram showing the outline of the operation of the information processing apparatus according to the first embodiment;

FIG. 5 is a schematic diagram showing the outline of the operation of the information processing apparatus according to the first embodiment;

FIGS. 6A and 6B are schematic diagrams for explaining a stitching process according to the first embodiment;

FIGS. 7A and 7B are schematic diagrams for explaining the stitching process according to the first embodiment;

FIGS. 8A and 8B are schematic diagrams for explaining the stitching process according to the first embodiment;

FIGS. 9A and 9B are schematic diagrams showing an example of a synthesis image;

FIGS. 10A and 10B are schematic diagrams showing an example of the synthesis image;

FIGS. 11A-D are diagrams for explaining a problem which may be caused in the stitching process;

FIGS. 12A and 12B are schematic diagrams each showing an example of a synthesis image on which reproducibility of a subject on coupling positions of a plurality of image areas is reflected;

FIG. 13 is a schematic diagram for explaining the operation of an information processing apparatus according to a second embodiment of the present disclosure;

FIG. 14 is a schematic diagram for explaining the operation of an information processing apparatus according to the second embodiment of the present disclosure;

FIG. 15 is a schematic diagram showing another example of a connection area image shown in FIG. 14;

FIG. 16 is a schematic diagram for explaining switching of the display of a subject image, the synthesis image, and the connection area image;

FIG. 17 is a schematic diagram for explaining the operation of an information processing apparatus according to a third embodiment of the present disclosure;

FIG. 18 is a schematic diagram for explaining the operation of the information processing apparatus according to the third embodiment of the present disclosure;

FIG. 19 is a schematic diagram showing another example of a partial image shown in FIG. 18; and

FIGS. 20A and 20B are schematic diagrams each showing a modified example of an image that indicates a coupling position.

### DETAILED DESCRIPTION

Hereinafter, embodiments of the present disclosure will be described with reference to the drawings.

### First Embodiment

(Structure of Image Processing System)

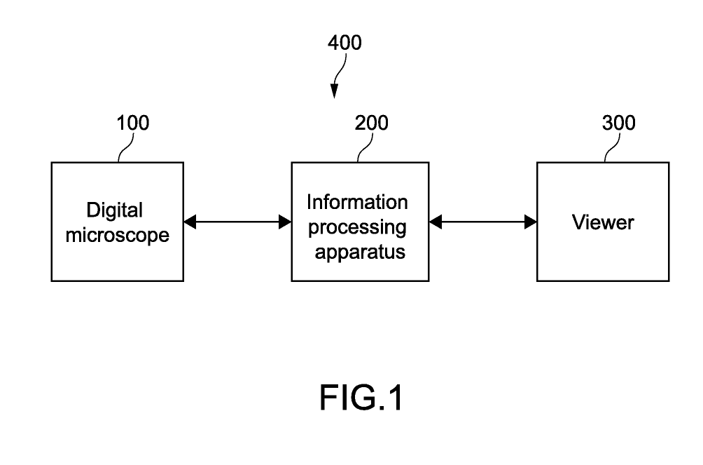

FIG. 1 is a schematic diagram showing an image processing system according to a first embodiment of the present disclosure. As shown in FIG. 1, an image processing system 400 includes a digital microscope 100, an information processing apparatus 200, and a viewer 300.

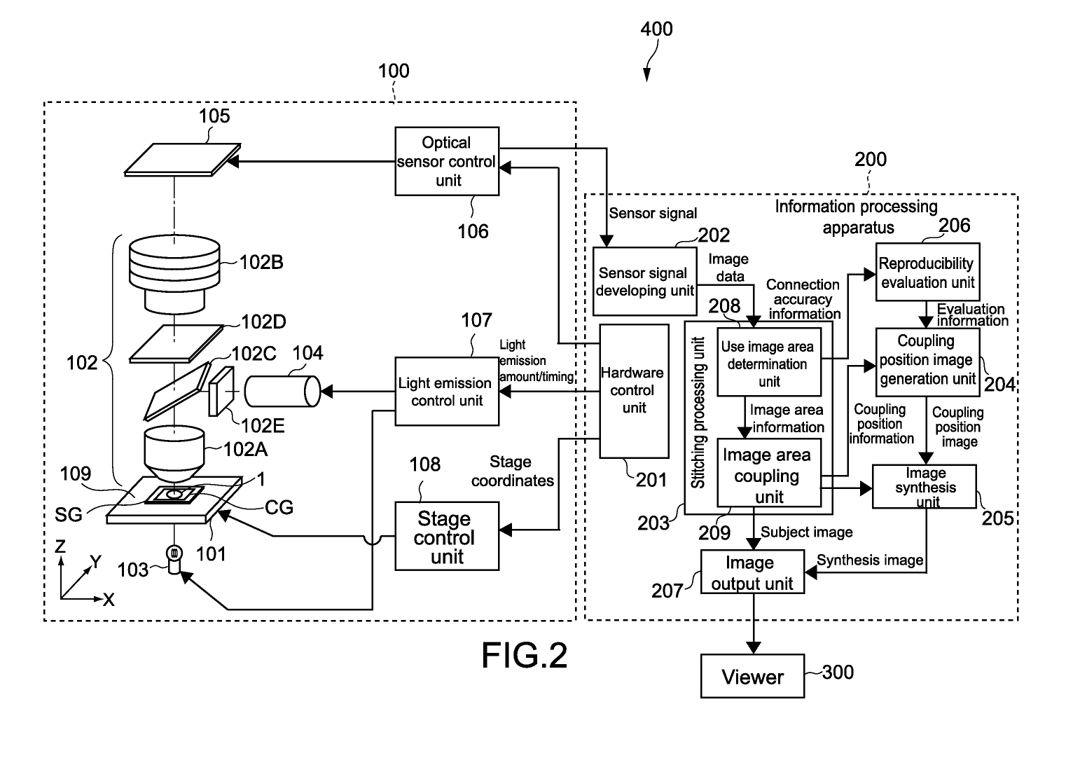

FIG. 2 is a schematic diagram showing a structural example of the digital microscope 100 and the information processing apparatus 200.

The digital microscope 100 includes a stage 101, an optical system 102, an illumination lamp 103, a light source 104, an optical sensor 105, an optical sensor control unit 106, a light emission control unit 107, and a stage control unit 108.

The stage 101 has a placement surface 109 on which a subject 1 as an image taking target is placed. The subject 1 is, for example, a sample of a tissue slice, a cell, or a biopolymer such as a chromosome, but is not limited to those.

The stage 101 is movable in three axis directions which are perpendicular to each other. In other words, the stage 101 is movable in an X axis direction and a Y axis direction which are perpendicular to each other in a plane direction of the placement surface 109. Further, the stage 101 is movable in a Z axis direction along an optical axis of an objective lens 102A of the optical system 102.

The subject 1 is fixed in position by a predetermined fixation method by being disposed between a slide glass SG and a cover glass CG and is subjected to stain as necessary. The stain method includes general stain methods such as HE (hematoxylin eosin) stain, Giemsa stain, and Papanicolaou stain, and fluorescence stain such as FISH (Fluorescence In Situ Hybridization) and an Enzyme labeled antibody method. The fluorescence stain is performed to mark a specific target in the subject 1, for example.

The optical system 102 is provided above the stage 101 and is constituted of the objective lens 102A, an imaging lens 102B, a dichroic mirror 102C, an emission filter 102D, and an excitation filter 102E. The light source 104 is formed of an LED (light emitting diode) or the like.

The objective lens 102A and the imaging lens 102B scale up an image of the subject 1 obtained by the illumination lamp 103 at a predetermined magnification and cause the scaled-up image to be imaged on an image pickup surface of the optical sensor 105.

The excitation filter 102E causes only light having an excitation wavelength that excites a fluorochrome out of light emitted from the light source 104 to pass therethrough to generate excitation light. The dichroic mirror 102C causes the incident excitation light that passes through the excitation filter to be reflected thereon to guide the light to the objective lens 102A. The objective lens 102A collects the excitation light to the subject 1.

In the case where the fluorescence stain is performed on the subject 1 fixed to the slide glass SG, the fluorochrome emits light by the excitation light. The light (color producing light) obtained by the light emission passes through the dichroic mirror 102C via the objective lens 102A and reaches the imaging lens 102B via the emission filter 102D.

The emission filter 102D absorbs light (outside light) except the color producing light scaled up by the objective lens 102A. An image of the color producing light obtained after the outside light is lost is scaled up by the imaging lens 102B and imaged on the optical sensor 105.

The illumination lamp 103 is provided below the stage 101 and irradiates the subject 1 placed on the placement surface 109 with illumination light through an opening (not shown) formed on the stage 101.

As the optical sensor 105, a CCD (Charge Coupled Device), a CMOS (Complementary Metal Oxide Semiconductor), or the like is used. The optical sensor 105 may be provided integrally with the digital microscope 100 or may be provided in an image-pickup apparatus (such as a digital camera) which is separated from the digital microscope 100 but can be coupled thereto.

The optical sensor control unit 106 controls the optical sensor 105 on the basis of a control command from the information processing apparatus 200. Further, the optical sensor control unit 106 takes in an output from the optical sensor 105 and transfers the output to the information processing apparatus 200.

The light emission control unit 107 performs control relating to exposure, such as an exposure time period or a light intensity of the illumination light 103 or the light source 104, on the basis of the control command from the information processing apparatus 200.

The stage control unit 108 controls the movement of the stage 101 in the XYZ axis directions on the basis of the control command from the information processing apparatus 200.

The information processing apparatus 200 may be, for example, an apparatus having typical computer hardware elements such as a PC (Personal Computer). The information processing apparatus 200 controls the digital microscope 100 and can store images of the subject 1 which are taken by the digital microscope 100 as digital image data in a predetermined format.

The information processing apparatus 200 has, as a functional structure attained with the use of the typical computer hardware elements, a hardware control unit 201, a sensor signal developing unit 202, a stitching processing unit 203, a coupling position image generation unit 204, an image synthesis unit 205, a reproducibility evaluation unit 206, and an image output unit 207. Those are attained by a program for operating the information processing apparatus 200. Alternatively dedicated hardware may be used as appropriate.

The sensor signal developing unit 202 generates digital image data from a sensor signal taken from the optical sensor 105 through the optical sensor control unit 106. The digital image data generated is supplied to the stitching processing unit 203.

In this embodiment, as will be described later, the image of the subject 1 is taken so that a plurality of image taking areas are overlapped with each other, thereby generating a plurality of partial images. Specifically, sensor signals relating to the plurality of partial images are output to the sensor signal developing unit 202. Then, the sensor signal developing unit 202 generates image data of the plurality of partial images. The image data of the partial images generated is supplied to the stitching processing unit 203. In the following description, the term “image” includes the image data of the image. In this embodiment, the sensor signal developing unit 202 functions as an obtaining unit.

The stitching processing unit 203 has a use image area determination unit 208 and an image area coupling unit 209. The use image area determination unit 208 determines an area to be used to generate the image of the subject 1 for each of the plurality of partial images obtained. Then, those are calculated as a plurality of image areas. In this embodiment, the use image area determination unit 208 functions as a calculation unit.

The image area coupling unit 209 couples the plurality of image areas calculated by the use image area determination unit 208 with each other to generate a subject image. In this embodiment, the image area coupling unit 209 functions as a generation unit.

The coupling position image generation unit 204 obtains information relating to coupling positions of the plurality of image areas from the image area coupling unit 209. On the basis of the coupling position information, coupling position images, which are images indicating the coupling positions of the plurality of image areas, are generated.

The image synthesis unit 205 synthesizes the coupling position images generated by the coupling position image generation unit 204 to the subject image generated by the image area coupling unit 209. In this embodiment, the image synthesis unit 205 functions as a synthesis unit.

The image output unit 207 converts digital image data supplied from the sensor signal developing unit 202 into a file format which is easily processed on a computer, such as JPEG (Joint Photographic Experts Group) and Tiff (Tagged Image File Format) and stores the data as a file in a storage unit 217 or the like.

The hardware control unit 201 controls the optical sensor control unit 106, the light emission control unit 107, and the stage control unit 108 in the digital microscope 100.

The viewer 300 is used to view various images generated by the image processing apparatus 200. The viewer 300 receives an image file from the information processing apparatus 200 and restores the digital image data from the image file, to cause the image to be displayed on a display (not shown).

The viewer 300 is, for example, a PC or the like and is connected to the information processing apparatus 200 via a network such as a LAN (Local Area Network) and a WAN (Wire Area Network). However, a device used as the view 300, a connection method with the information processing apparatus 200, and the like are not limited, and various devices or methods may be used.

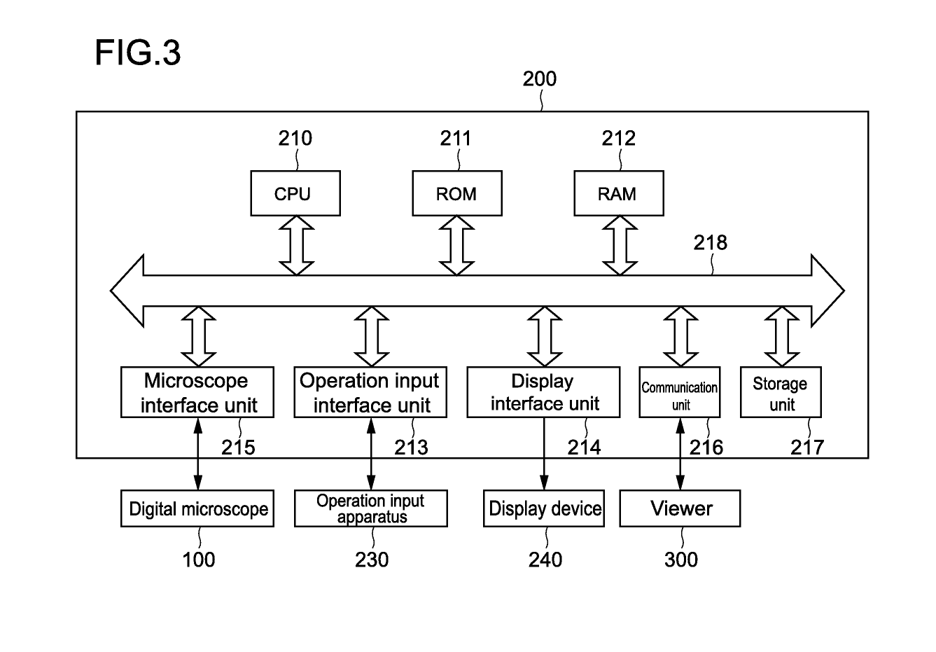

FIG. 3 is a block diagram showing a hardware structure of the information processing apparatus 200.

As shown in the figure, the information processing apparatus 200 is provided with a CPU (Central Processing Unit) 210, a ROM (Read Only Memory) 211, a RAM (Random Access Memory) 212, an operation input interface unit 213, a display interface unit 214, a microscope interface unit 215, a communication unit 216, the storage unit 217, and a bus 218 which connects those with each other.

The ROM 211 fixedly stores programs and data for operating the information processing apparatus 200. The RAM 212 is used as a main memory of the CPU 210. The storage unit 217 is a readable and writable storage apparatus such as an HDD (Hard Disk Drive), a flash memory, and other solid-state memory. Further, the storage unit 217 is used as a storage area of data of the images taken and stores programs which are loaded by the RAM 212 and executed by the CPU 210.

The program is installed in the information processing apparatus 200 via a recording medium, for example. Alternatively, the program may be installed via a global network or the like.

The operation input interface unit 213 is an interface for connection with an operation input apparatus 230 by a user, such as a keyboard, a mouse, and a touch panel. The display interface unit 214 is an interface for connection with a display apparatus 240 such as a liquid crystal display, an EL (Electro-Luminescence) display, a plasma display, and a CRT (Cathode Ray Tube) display. The microscope interface unit 215 is an interface for connection with the digital microscope 100.

The communication unit 216 is a modem, a router, or another communication apparatus for communicating with another device, which is capable of being connected with a LAN, a WAN, or the like. The communication unit 216 may perform wire or wireless communication. The communication unit 216 may be used independently of the information processing apparatus 200.

(Operation of Information Processing Apparatus)

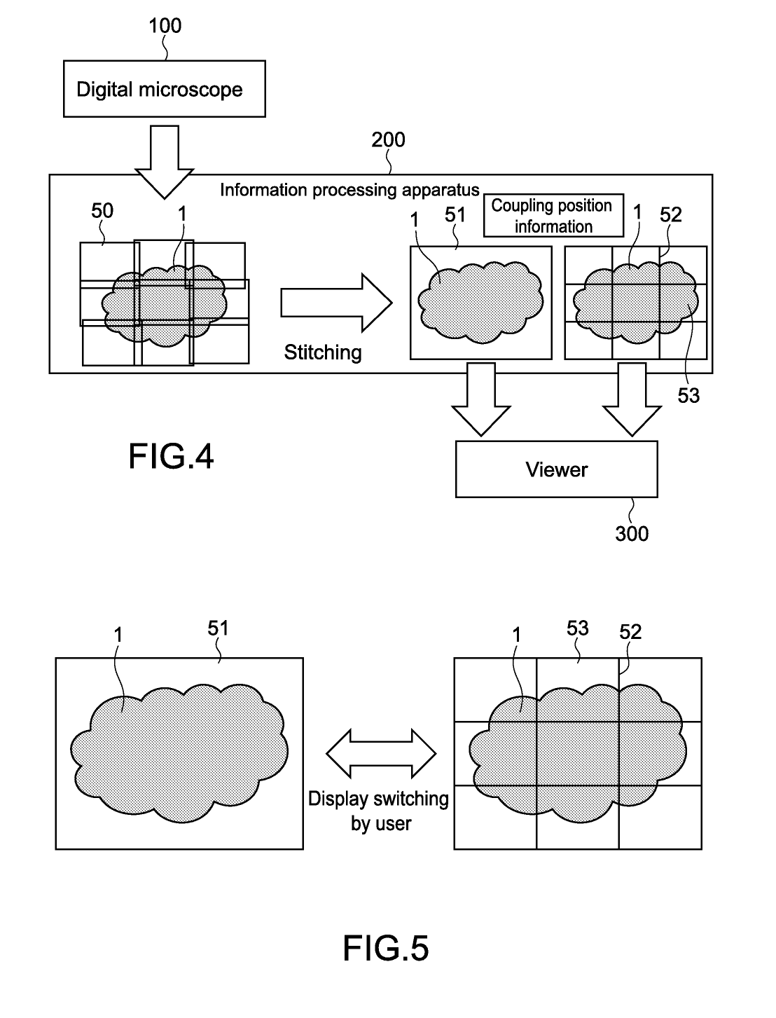

FIGS. 4 and 5 each are schematic diagrams showing the outline of the operation of the information processing apparatus 200 according to this embodiment.

As shown in FIG. 4, on the basis of the sensor signals from the digital microscope 100, a plurality of partial images 50 of the subject 1 are obtained. The stitching processing unit 203 synthesizes the plurality of partial images 50 to generate a subject image 51.

Further, the coupling position image generation unit 204 generates a coupling position image 52 on the basis of coupling position information. Then, the image synthesis unit 205 synthesizes the coupling position image 52 with respect to the subject image 51 to generate a synthesis image 53. The subject image 51 and the synthesis image 53 are output to the viewer 300.

For example, as shown in FIG. 5, the subject image 51 and the synthesis image 53 are displayed on the display in a switched manner by a display switch operation by a user. Alternatively, both the images may be displayed on the display at the same time. Displaying the synthesis image 53 obtained by synthesizing the coupling position image 52 with respect to the subject image 51 makes it possible to effectively use the subject image 51 for a diagnosis or the like in the field of medicine, for example.

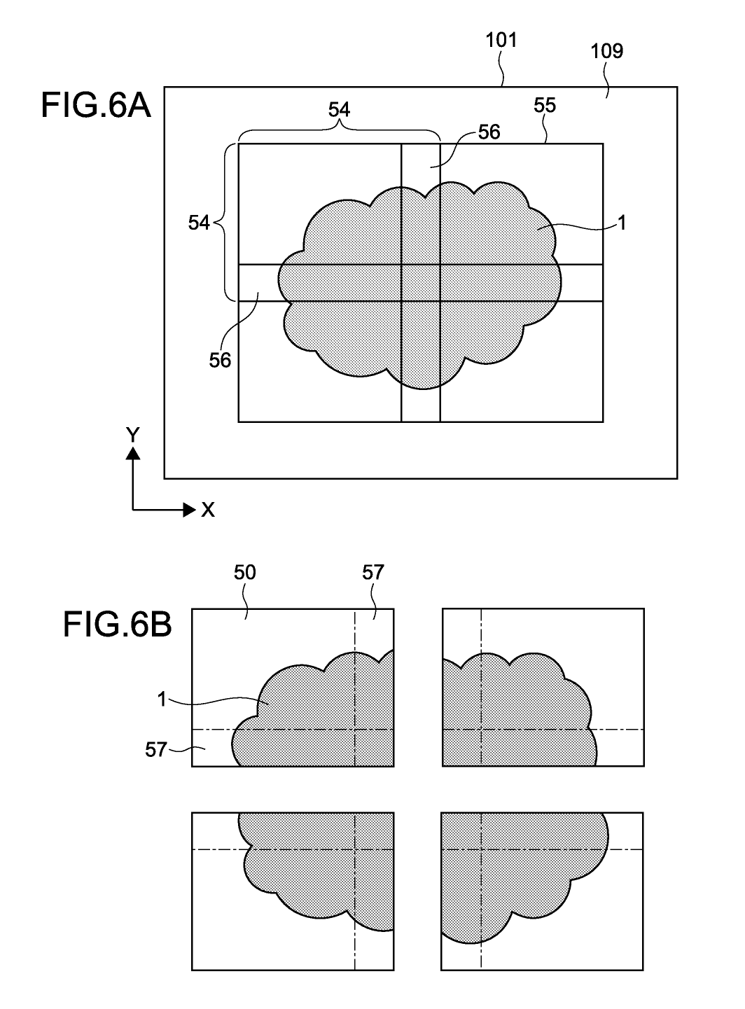

Hereinafter, the operation of the information processing apparatus 200 will be described in detail. FIGS. 6 to 8 are schematic diagrams for explaining the stitching process according to this embodiment.

FIG. 6A is a diagram showing a movement of an image taking area 54 with respect to the subject 1 on the placement surface 109 of the stage 101. An entire area 55 an image of which is to be taken on the placement surface 109 of the stage 101 is a rectangle generally. The image taking area 54 which is smaller than the entire area 55 corresponds to an area in a single image taking. The image taking area 54 is selectively moved in the X-axis direction and the Y-axis direction with respect to the entire area 55, and the image of the image taking area 54 is repeatedly taken for each selective movement, thereby taking the image of the entire area 55.

The stage 101 and the optical system 102 only have to be movable in the XYZ-axis directions relative to each other. In this embodiment, the optical system 102 is fixed in position, and the stage 101 is movable in the XYZ-axis directions. In contrast, however, the stage 101 may be fixed in position, and the optical system 102 may be selectively movable in the XYZ-axis directions.

The size of the image taking area 54 and the amount of the movement in each of the X-axis direction and the Y-axis direction are set so that a predetermined overlap 56 is generated between the image taking areas 54 adjacent to each other in each of the X-axis direction and the Y-axis direction. For example, the amount of a single movement of the image taking area 54 in the X-axis direction is set to approximately 60% to 95% of the size of the image taking area 54 in the X-axis direction. Further, the size of the overlap 56 in the X-axis direction between the image taking areas 54 adjacent in the X-axis direction is set to approximately 5% to 20% of the size of the image taking area 54 in the X-axis direction. Those proportions may also be applied to the case of the Y-axis direction of the image taking area 54.

The number of image taking areas 54, the sizes thereof, the order of image taking thereof, the size of the overlap 56, and the like are not limited and may be appropriately set.

As described above, the images of the plurality of image taking areas 54 are taken with respect to the subject 1 so as to be overlapped with each other, with the result that the plurality of partial images 50 are generates as shown in FIG. 6B. The plurality of partial images 50 each have connection areas 57. The connection area 57 is an area corresponding to the overlap 56, where the image taking areas 54 the images of which are taken are overlapped with each other.

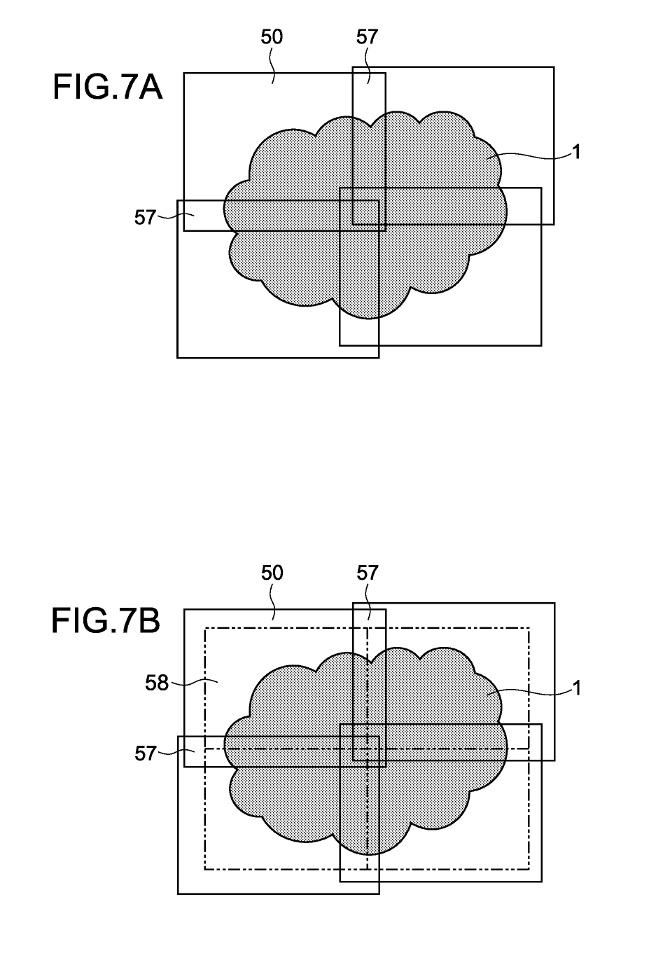

As shown in FIG. 7A, the use image area determination unit 208 of the information processing apparatus 200 connects the plurality of partial images 50. The connection of the plurality of partial images 50 in this case refers to an arrangement of the plurality of partial images 50 in an appropriate positional relationship. For example, a position where the plurality of partial images 50 are appropriately connected is calculated with a coordinate value or the like.

For example, an error may be caused in a relative positional relationship among the plurality of partial images 50 due to a movement error of the stage 101, an error in image taking accuracy, or the like. In other words, the relative positional relationship among the plurality of partial images 50 may be deviated as compared to the relative positional relationship among the plurality of image taking areas 54 shown in FIG. 6A. Accordingly, in this embodiment, the plurality of partial images 50 are connected with each other with the connection areas 57 held by the partial images 50 set as references.

In this embodiment, the connection areas 57 of the partial images 50 are subjected to a matching process, and optimal connecting positions are determined. The matching process is performed by calculating a brightness value for each pixel of the connection areas 57 and calculating a correlation coefficient on the basis of the brightness value, for example. Alternatively, the matching process may be performed by calculating the square of a difference of the brightness value for each pixel of the connection areas 57. Alternatively, a frequency component of the connection areas 57 may be used. In addition, various algorisms used for an image pattern matching may be used.

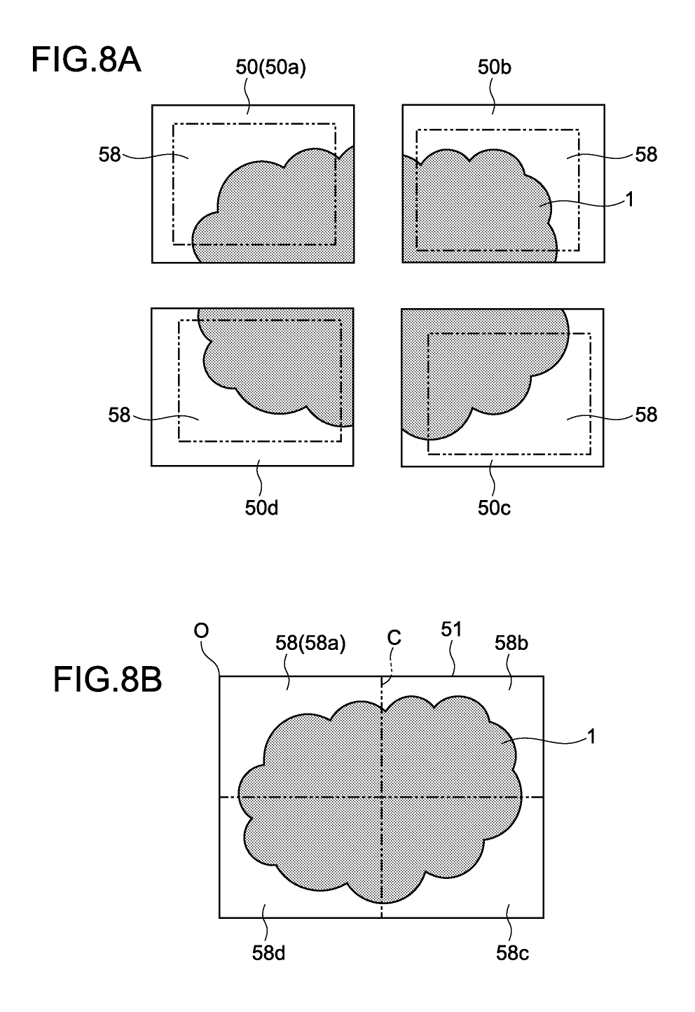

When the plurality of partial images 50 are connected with each other on optimal connecting positions, as shown in FIG. 7B, areas used to generate the subject image 51 are determined, and those are calculated as a plurality of image areas 58. As shown in FIG. 8A, in this embodiment, for each of the plurality of partial images 50, the image area 58 is calculated.

The image areas 58 are areas used as parts that constitute the subject image 51. In other words, pixels (image information) in the image area 58 are used as pixels (pixel information) that constitute the subject image 51.

In this embodiment, before the images of the plurality of image taking areas 54 are taken in FIG. 6A, areas (not shown) corresponding to the plurality of image areas 58 are predetermined. With the areas being set as references, the positions and the sizes of the plurality of image taking areas 54 are set. Then, The plurality of partial images 50 are connected on appropriate positions in FIG. 7A, and thereafter the image areas 58 are calculated with the predetermined areas as references. As a result, it is possible to execute the determination process of the image areas 58 at a smaller load.

However, after the plurality of partial images 50 are connected, the plurality of image areas 58 may be calculated as appropriate on the basis of the connection result. For example, the plurality of image areas 58 having shapes or sizes different from each other may be calculated.

As shown in FIG. 8B, the plurality of image areas 58 calculated are coupled with each other by the image area coupling unit 209, thereby generating the subject image 51. In FIG. 8B, for ease of explanation, coupling positions C serving as boundaries of the plurality of image areas 58 are indicated by dashed-two dotted lines. However, the coupling positions C are not indicated in the subject image 51 actually.

In an upper left area 58a, which is one of areas separated by the dashed-two dotted lines, pixels of a partial image 50a shown in FIG. 8A are used, and in an upper right area 58b, pixels of a partial image 50b are used. In a lower right area 58c, pixels of a partial image 50c are used, and in a lower left area 58d, pixels of a partial image 50d are used. That is, the pixels of different partial images 50 are arranged with the coupling positions C indicated by the dashed-two dotted lines being disposed therebetween.

The coupling position image generation unit 204 generates a coupling position image 52 on the basis of information of the coupling positions C of the plurality of image areas 58. As the information of the coupling positions C, for example, coordinate information of a plurality of coupling pixels aligned along the coupling positions C in the each of the image areas 58 are used. For example, a coordinate system is determined with a point O at the upper left of the subject image 51 shown in FIG. 8B being set as a reference. In the coordinate system, coordinate values of the coupling pixels are determined.

As the information relating to the coupling positions C, size information of the image areas 58 may be used. A part of the plurality of coupling pixels is selected as a representative, and the coordinate information of the coupling pixels may be used as the information relating to the coupling positions C. In addition, as information for detecting the coupling positions C, any information may be used.

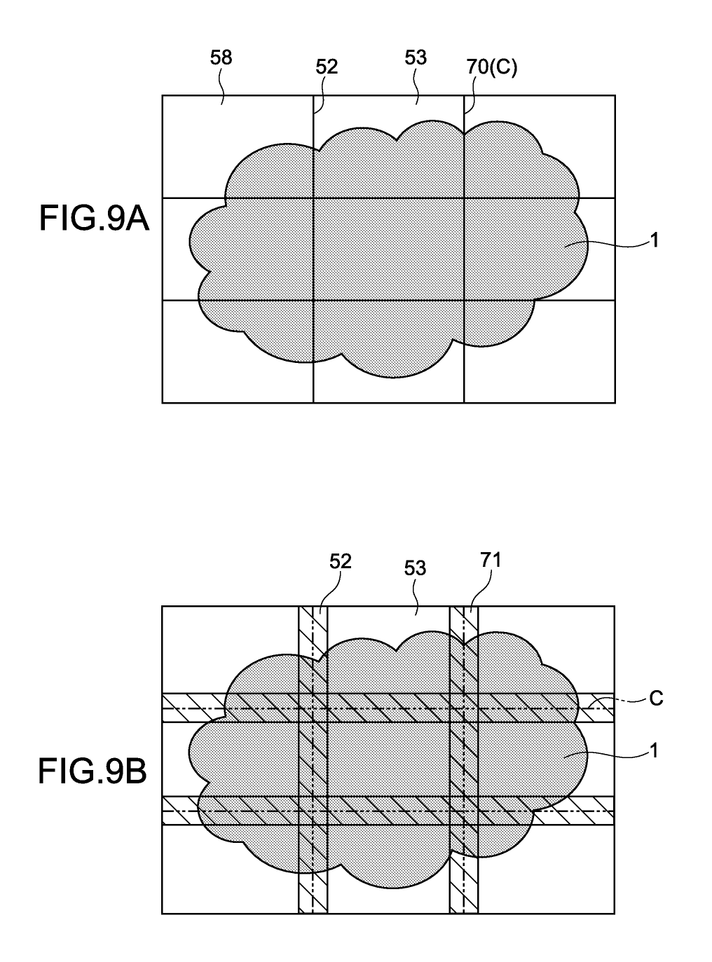

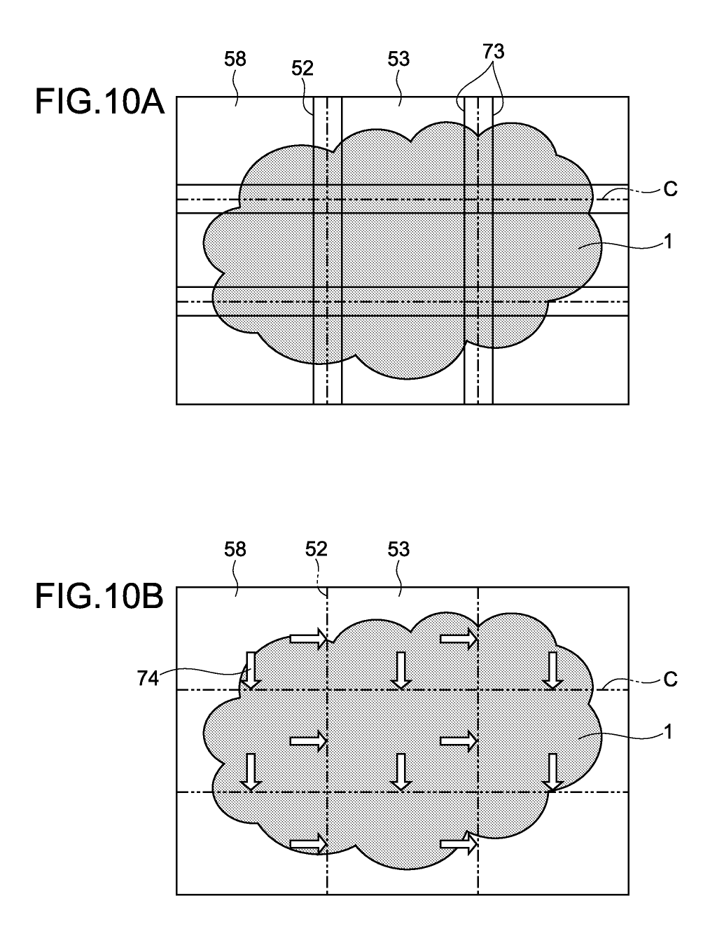

The image synthesis unit 205 synthesizes the coupling position images 52 and the subject image 51 with each other, to generate the synthesis image 53. FIGS. 9 and 10 are schematic diagrams each showing an example of the synthesis image 53. It should be noted that in FIGS. 9 and 10, six image areas 58 are coupled to generate the subject image 51.

In FIG. 9A, in the coupling pixels of the image areas 58, color such as red, yellow, or fluorescent color is displayed. That is, in the synthesis image 53, lines 70 colored are displayed along the coupling positions C. Thus, the user can grasp the coupling positions C of the plurality of image areas 58.

In FIG. 9B, as the coupling position image 52, a coupling area 71 which is an area including the coupling position C is displayed. The entire coupling area 71 is colored, for example. Alternatively, the coupling area 71 may be semitransparent. In this embodiment, the coupling area 71 is the area having the coupling position C as the center. However, the size, the shape, or the like of the coupling area 71 can be appropriately set. In this way, the coupling area 71 including the coupling position C may be displayed as the coupling position image 52.

As the coupling position image 52 indicating the coupling position C, an image (for example, line 70 shown in FIG. 9A) which enables the user to grasp the coupling position C in detail may be displayed. Alternatively, an image (for example, coupling area 71 shown in FIG. 9B) which enables the user to grasp a range including the coupling position C may be displayed.

In FIG. 10A, color or the like is displayed on the pixel disposed on the fifth pixel from the coupling position C, for example. That is, in the synthesis image 53, as the coupling position image 52, two lines 73 are displayed with the coupling position C being disposed therebetween (dashed-two dotted lines that indicate the coupling positions C are not displayed). As a result, the user can grasp that the center between the two lines 73 is the coupling position C. Further, the user can sufficiently observe the subject 1 on the coupling position C.

In FIG. 10B, as the coupling position image 52, arrows 74 that indicate the coupling positions C are displayed (dashed-two dotted lines that indicate the coupling positions C are not displayed). In this way, to indicate the coupling position C, a GUI (Graphical User Interface) such as an arrow and an icon may be displayed as appropriate. The number of GUIs, the shape thereof, the color thereof, and the like are not limited. Further, in accordance with scrolling on the screen by the user, the arrows 74 or the like may be moved as appropriate. As a result, it is possible to sufficiently observe the subject 1 on the coupling positions C.

The coupling position images 52 shown in FIGS. 9 and 10 may be combined as appropriate. In addition, various images can be used as the coupling position images 52.

As described above, in the information processing apparatus 200 according to this embodiment, the areas used for each of the plurality of partial images 50 are determined, and those are calculated as the plurality of image areas 58. By coupling the plurality of image areas 58 with each other, the subject image 51 is generated. The coupling position images 52 that indicate the coupling positions C of the plurality of image areas 58 in the subject image 51 generated are synthesized with respect to the subject image 51. As a result, the synthesis image 53 as exemplified in FIGS. 9 and 10 is generated. Accordingly, it is possible to grasp the coupling positions C of the plurality of image areas 58, in which the subject 1 may not be appropriately displayed. As a result, for example, in the diagnosis or the like in the field of medicine, for example, it is possible to effectively use the subject image 51 obtained by synthesizing the plurality of partial images 50.

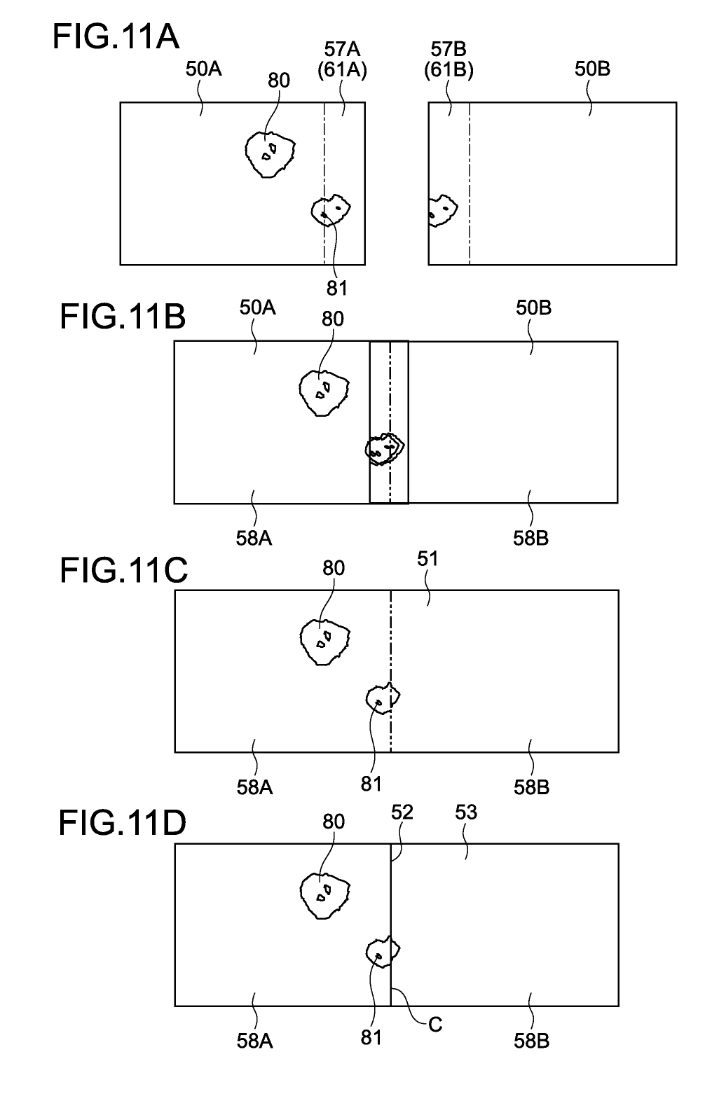

Here, with reference to FIGS. 11, a problem which may be caused by the stitching process will be described. For example, as shown in FIG. 11A, the assumption is made that a fluorescent image 80 of a cell and a fluorescent image 81 of a nucleus are displayed in partial images 50A and 50B to be connected. As shown in FIG. 11B, the matching process is performed on connection areas 57A and 57B. For the partial images 50A and 50B, image areas 58A and 58B are calculated, respectively. In FIG. 11B, the left side of the dashed-two dotted line corresponds to the image area 58A of the partial image 50A, and the right side of the dashed-two dotted line corresponds to the image area 58B of the partial image 50B.

At this time, the case may occur in which the accuracy of the matching process is low, resulting in an inappropriate calculation of the image areas 58A and 58B. In this case, if the image areas 58A and 58B are coupled, the subject image 51 from which the fluorescent image 81 of the nucleus is partially lost may be generated as shown in FIG. 11C. Further, there is only one nucleus actually, but two may be displayed. As a result, for example, a misdiagnosis may be made in the field of medicine, for example. Further, a problem may arise in an observation or the like in a cell culture experiment, for example.

However, in the information processing apparatus 200 according to this embodiment, as shown in FIG. 11D, the coupling position image 52 that indicates the coupling position C of the image areas 58A and 58B is synthesized with respect to the subject image 51, to generate the synthesis image 53. Therefore, a doctor or the like can grasp the coupling position C of the image areas 58A and 58B.

As a result, it is possible for a doctor or the like to observe the fluorescent images 80 and 81 with care to make a diagnosis. That is, it is possible to make a diagnosis while sufficiently investigating whether the shapes or the like of the fluorescent images 80 and 81 displayed on the coupling position C are affected by the coupling process. For example, in the case where the shapes or the like of the fluorescent images 80 and 81 are abnormal, it is possible to sufficiently investigate whether the abnormality is in a cell or the like or is caused due to the coupling process. Thus, it is possible to prevent a misdiagnosis or the like which may be caused due to the subject which is not appropriately displayed on the coupling position C. In other words, it is possible to effectively use the subject image 51 generated by the stitching process.

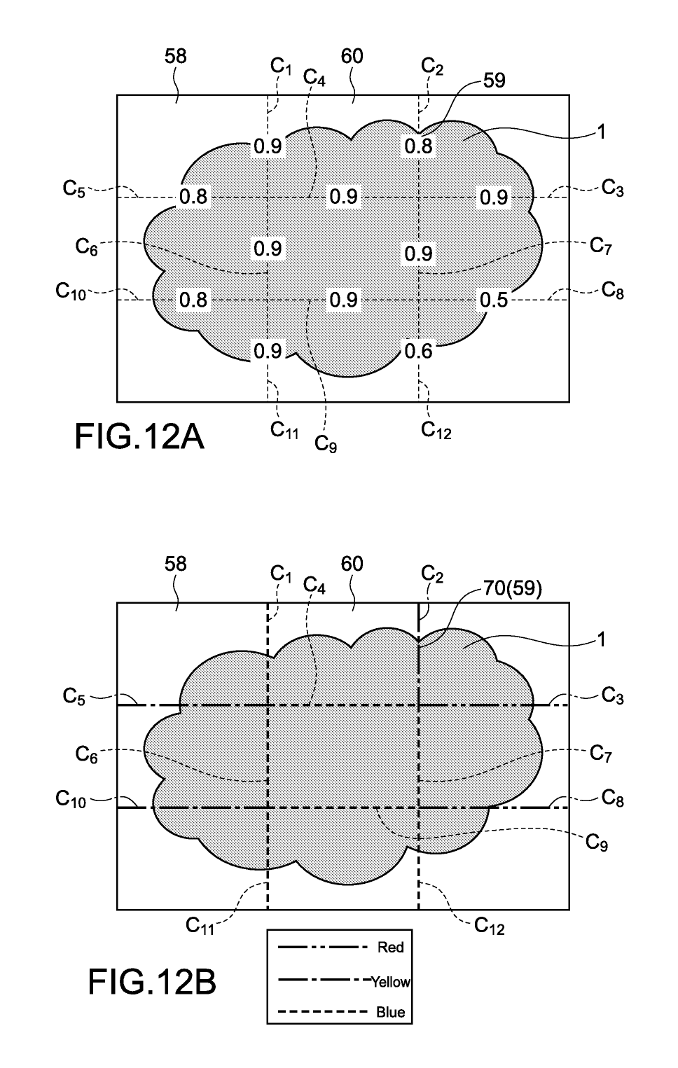

FIGS. 12 are schematic diagrams each showing an example in which an image 59 on which the reproducibility of the subject 1 on the coupling positions C of the plurality of image areas 58 is reflected is synthesized with respect to the subject image 51. In this embodiment, such a synthesis image 60 can be displayed through a display switch operation by the user.

The reproducibility of the subject 1 on the coupling positions C is reflected by the reproducibility evaluation unit 206 shown in FIG. 2. In this embodiment, every two image areas 58 adjacent to each other out of the plurality of image areas 58, the reproducibility of the subject 1 on coupling positions C₁ to C₁₂ of the two image areas 58 is evaluated. In FIG. 12, nine image areas 58 are coupled, and there are twelve coupling positions C₁ to C₁₂ of the two image areas 58 coupled with each other, respectively. For each of the twelve coupling positions C₁ to C₁₂, the reproducibility of the subject 1 is evaluated.

In this embodiment, on the basis of connection accuracy at the time when the plurality of partial images 50 described above with reference to FIG. 7A are connected, the reproducibility of the subject 1 on the coupling positions C₁ to C₁₂ is evaluated. In other words, results of the matching processes of the connection areas 57 held by the plurality of partial images 50 are used for the evaluation of the reproducibility.

In the case where the connection accuracy of the connection areas 57 in the matching process is high, it is thought that determination accuracy of the image areas 58 determined in the partial images 50 and coupling accuracy of the image areas 58 are high. Therefore, it is possible to evaluate the reproducibility on the basis of the connection accuracy of the connection areas 57.

In FIG. 12A, as the image 59 on which the reproducibility is reflected, a numerical value is displayed on each of the coupling positions C₁ to C₁₂, respectively. The numerical value indicates a correlation coefficient of the connection areas 57 which have been subjected to the matching process.

It should be noted that another numerical value may be calculated on the basis of the correlation coefficient and may be displayed as a parameter that indicates the reproducibility. Further, another numerical value relating to the matching process such as a standard deviation and a square of a difference of the brightness values may be used as appropriate.

In FIG. 12B, the lines 70 that indicate the coupling positions C are color-coded and displayed. As shown in FIG. 12B, dashed-two dotted lines represent red, dashed-dotted lines represent yellow, and broken lines represent blue.

As described above, the evaluation of the reproducibility of the subject 1 is reflected, and the lines 70 that indicate the coupling positions C may be color-coded as appropriate. The lines 70 color-coded are also displayed as coupling position images, and also displayed as the images 59 on which the evaluation of the reproducibility is reflected. For example, the coupling area 71 shown in FIG. 9B, the arrows 74 shown in FIG. 10B, or the like may be color-coded and displayed as appropriate.

As described above, in the information processing apparatus 200 according to this embodiment, the reproducibility of the subject 1 is evaluated on the coupling positions C (C₁ to C₁₂), and the image 59 or 70 on which the reproducibility evaluated is reflected is synthesized with respect to the subject image 51. As a result, it is possible to appropriately observe the subject image 51 on the basis of the reproducibility. Further, in this embodiment, it is possible to use the result of the connection process of the plurality of partial images 50 for the evaluation of the reproducibility. Thus, it is possible to execute the reproducibility evaluation process with a smaller load.

It should be noted that, in this embodiment, the reproducibility of the subject is evaluated every two image areas 58 coupled with each other, but the reproducibility of the subject for the entire coupling positions C may be evaluated. In other words, the coupling accuracy may be evaluated for each subject image 51. As a result, it is possible to reduce the load on the evaluation process.

To evaluate the reproducibility of the subject 1 on the coupling positions c, a method other than the method that uses the result of the matching process described above may be used. For example, with the use of a thumbnail image or the like obtained by taking an image of the entire subject 1 at a single time, the shape or the like of the subject 1 displayed is compared, and the reproducibility on the coupling positions C may be represented. Alternatively, a change or the like in the brightness value of pixels arranged with coupling position C being disposed therebetween is detected, and the reproducibility may be evaluated on the basis of the change in the brightness value.

### Second Embodiment

An information processing apparatus according to a second embodiment of the present disclosure will be described. In the following, a description of the structure and action which are the same as those of the information processing apparatus 200 described in the above embodiment will be omitted or simplified.

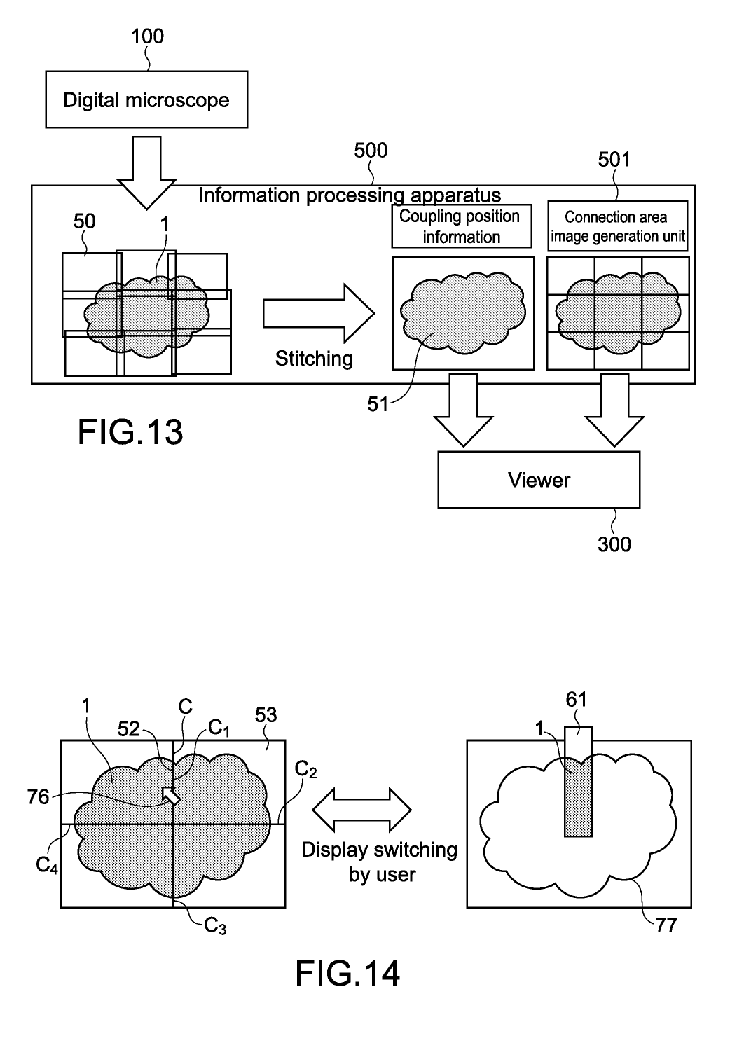

FIGS. 13 and 14 are schematic diagrams for explaining the operation of an information processing apparatus 500 according to this embodiment.

The information processing apparatus 500 according to this embodiment includes a connection area image generation unit 501 which generates an image of the connection area from the partial image 50. The connection area image generation unit 501 may be implemented by a program for causing the information processing apparatus 500 to operate, or dedicated hardware may be used therefore.

A connection area image 61 is an image of the connection area 57 shown in FIG. 6B, that is, an image obtained by cutting out the connection area 57 from the partial image 50. The connection area image 61 is capable of being generated from size information or the like of the connection area 57.

In the connection process of the plurality of partial images 50 shown in FIG. 7A, the case may arise in which the connection area image 61 is cut out, and the matching process is executed. In this case, the connection area image 61 cut out may be used as it is. As a result, it is possible to reduce the load on the process of generating the connection area image 61. Further, it is possible to reduce the process time period. It should be noted that in this case, the use image area determination unit 208 functions as the connection area image generation unit 501.

The connection area image 61 generated is stored in the storage unit or the like. Then, an instruction to confirm the subject 1 displayed on the coupling position C from the user is received via the operation input interface unit (see, FIG. 3).

For example, as shown in FIG. 14, the synthesis image 53 obtained by synthesizing the coupling position image 52 with respect to the subject image 51 is displayed. Further, on a screen, a pointer 76 which can be operated by using an operation input apparatus such as a mouse is displayed. The user uses the mouse or the like to move the pointer 76 onto the coupling position C. Then, the user presses a click button of the mouse or the like. In this way, the instruction to confirm the subject 1 displayed on the coupling position C may be input. However, the operation is not limited to the above operation, and various operations may be used.

The information processing apparatus 500 that has received the confirmation instruction from the user reads, from the storage unit or the like, at least one of the connection area images 61 that have been subjected to the matching process to determine the coupling position C. Then, the connection area image 61 read is output to the viewer 300. As a result, as shown in FIG. 14, the connection area image 61 is displayed on the display of the viewer 300.

In the connection area image 61, the subject 1 the image of which is taken is displayed as it is, and therefore the doctor or the like can confirm the subject 1. As a result, it is possible to observe the subject 1 displayed on the coupling position C in detail and make a diagnosis.

It should be noted that the connection area images 61 for the plurality of partial images 50 may be generated entirely or partially. In the example shown in FIG. 14, from each of four partial images 50, two connection area images 61 can be generated. That is, it is possible to generate eight connection area images 61. However, only four connection area images 61 corresponding to four coupling positions C₁ to C₄ may be generated. For example, as the connection area image 61 for the coupling position C₁, only the connection area image 61 of the upper left partial image 50 is generated. The connection area image 61 of the partial image 50 on the right side thereof may not have to be generated. As a result, it is possible to reduce the load with respect to process resources such as the CPU and the memory.

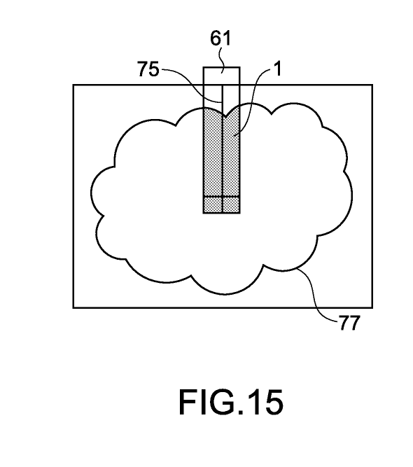

Further, as shown in FIG. 15, in the connection area image 61, an image 75 that indicates a position to be cut as the image area may be displayed. Thus, it is possible to grasp a part of the connection area image 61 which is to be used. As a result, it is possible to observe the subject image 51 in detail.

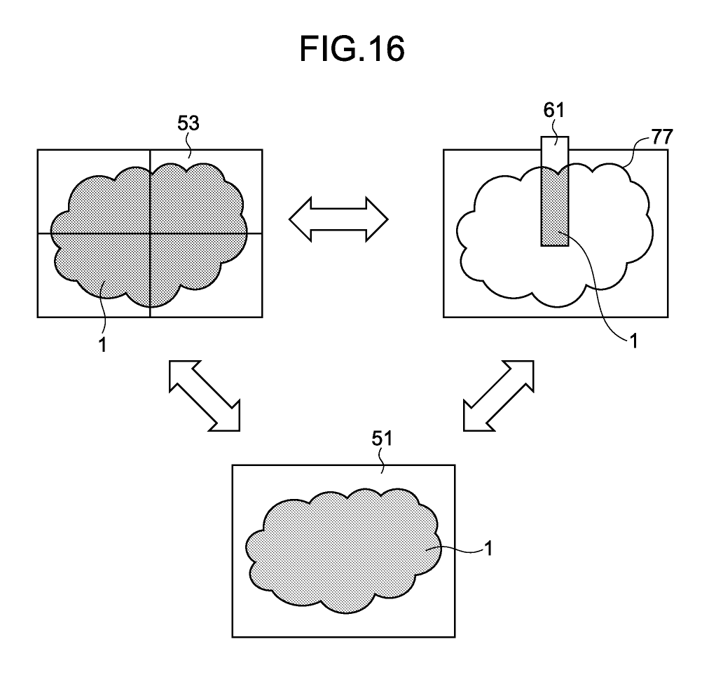

Furthermore, as shown in FIG. 16, the state in which the subject image 51 is displayed may be switched as appropriate to the state in which the connection area image 61 is displayed. As a result, it is possible to observe the subject 1 while switching the display of the subject image 51, the synthesis image 53, and the connection area image 61.

In FIGS. 14 to 16, the connection area image 61 is displayed in the state of being overlapped on an edge image 77 that indicates the edge of the subject 1, which makes the observation of the connection area image 61 easy. The display method of the connection area image 61 can be set as appropriate.

In this embodiment, the connection area image 61 generated is stored in the storage unit or the like. However, each time the confirmation instruction is received from the user, the connection area image 61 may be generated.

It should be noted that in the first embodiment above, the connection area image 61 may be generated and output as described in this embodiment.

### Third Embodiment

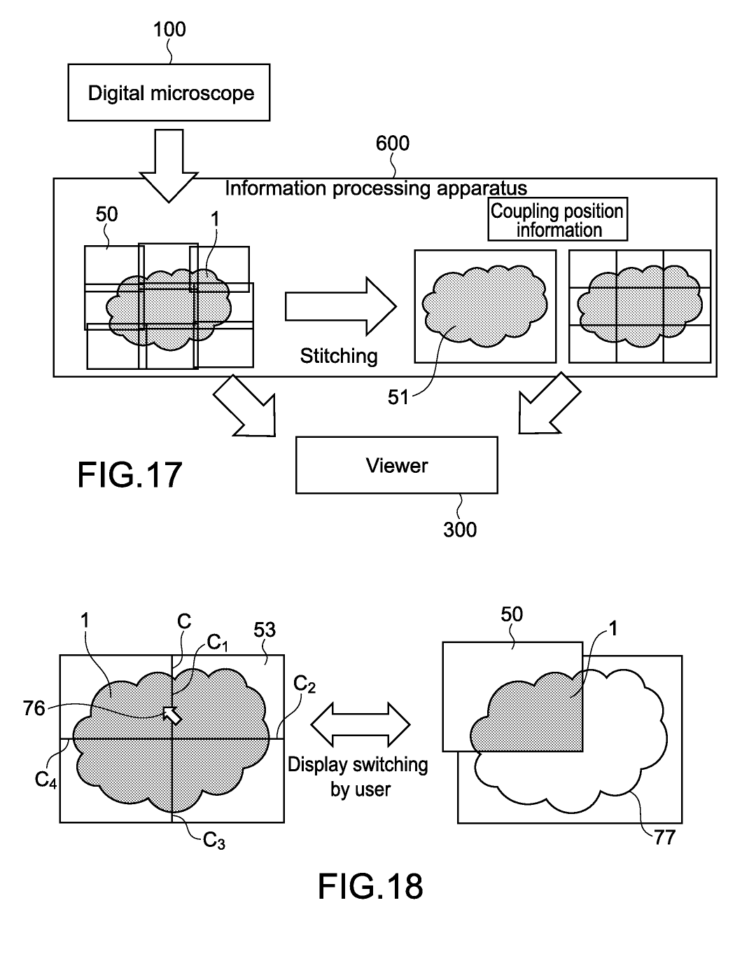

FIGS. 17 and 18 are schematic diagrams for explaining the operation of an information processing apparatus according to a third embodiment of the present disclosure.

An information processing apparatus 600 stores the plurality of partial images 50 in the storage unit. When a confirmation instruction of the subject 1 displayed on the coupling position C is input from the user, at least one of the partial images 50 coupled on the coupling position C is read from the storage unit. The partial image 50 read is output to the viewer 300 and displayed on the display as shown in FIG. 18.

In this way, the plurality of partial images 50 are stored, and on the basis of the confirmation instruction of the subject 1 displayed on the coupling position C, the partial image 50 may be read and output.

It should be noted that the plurality of partial images 50 may be entirely stored, or only a part of the partial images 50 may be stored. For example, to display four coupling positions C₁ to C₄, three partial images 50, specifically, an upper left partial image 50, an upper right partial image 50, and a lower left partial image 50 may be stored. As a result, it is possible to reduce the load on the process resources such as the CPU and the memory.

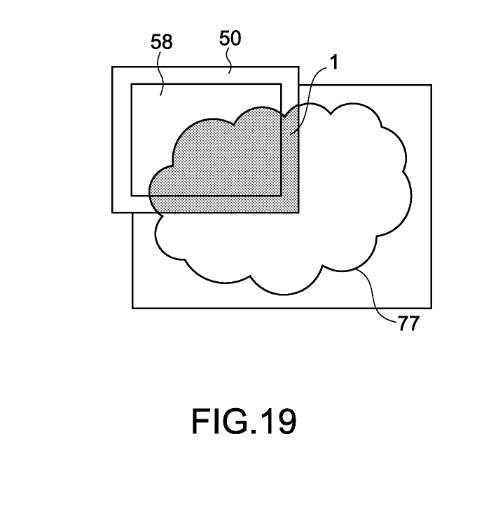

Further, as shown in FIG. 19, in the partial image 50, the image area 58 to be used may be displayed. As a result, it is possible to recognize an area to be used in the partial image 50. Further, the state in which the subject image 51 is displayed may be switched to the state in which the partial image 50 is displayed as shown in FIG. 18. As a result, it is possible to observe the subject 1 while switching the display of the subject image 51, the synthesis image 53, and the partial image 50. Further, the partial image 50 may be displayed with the use of the edge image 77, or another method may be used to display the partial image 50.

It should be noted that in the first embodiment described above, the partial image 50 may also be generated and output as described in this embodiment. Further, in the second embodiment, the display of the connection area image 61 and the display of the partial image 50 may be switched as appropriate.

### Modified Example

The present disclosure is not limited to the above embodiments and may be variously modified.

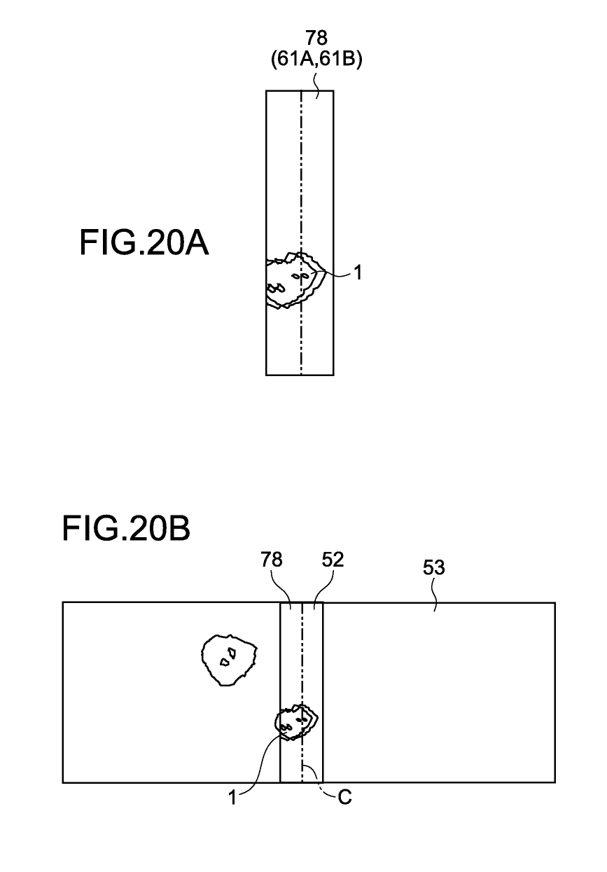

For example, FIGS. 20 are schematic diagrams each showing a modified example of an image that indicates the coupling position C. In this modified example, connection area images to be subjected to the matching process are subjected to a semitransparent synthesis through an alpha blend process.

In FIG. 20A, an image 61A of the connection area 57A shown in FIG. 11 and an image 61B of the connection area 57B are subjected to the semitransparent synthesis, to generate a semitransparent synthesis image 78. The two connection area images 61A and 61B are subjected to the semitransparent synthesis in a mutual positional relationship at the time of the matching process. Therefore, it is possible to grasp the connection accuracy of the connection areas 57A and 57B in the matching process.

As shown in FIG. 20B, in this embodiment, the semitransparent synthesis image 78 is synthesized with respect to the subject image as the image 52 that indicates the coupling position C. The display of the synthesis image 53 makes it possible to grasp the coupling position C and the reproducibility of the subject 1 on the coupling position C.

It should be noted that, as the image from which the accuracy of the overlap of the connection areas 57A and 57B can be grasped, another image may be used. For example, the edge portion of the subject 1 (fluorescent image of a cell or a nucleus) is calculated through an image recognition process or the like. An image on which the image that indicates only the edge portion is overlapped may represent the overlap accuracy of the connection areas 57A and 57B.

Further, for example, in FIG. 14, the connection area image 61 is displayed to confirm the subject 1 on the coupling position C. At this time, the semitransparent synthesis image 78 shown in FIG. 20A may also be displayed. As a result, it is possible to make a diagnosis or the like while grasping the reproducibility of the subject 1 on the coupling position C.

In the above description, the coupling position image that indicates the coupling position is generated and synthesized with respect to the subject image. However, the coupling position image and the subject image may be displayed on the display or the like without synthesis. For example, on a corner of the display on which the subject image is displayed, the coupling position image having a small size may be displayed.

In the above description, the reproducibility of the subject on the coupling position is evaluated, and on the basis of the information, the coupling position image on which the reproducibility is reflected is generated. However, separately from the coupling position image, an image on which the reproducibility is reflected may be generated. Then, the image generated is synthesized with respect to the subject image, the coupling position image, or the like.

In the above description, as shown in FIGS. 1 and 2, the digital microscope 100, the information processing apparatus 200, and the viewer 300 are independent of each other. However, for example, the information processing apparatus 200 may double as the viewer. In this case, it is sufficient that, for example, the display apparatus 240 shown in FIG. 3 displays the subject image, the synthesis image, or the like.

Alternatively, the digital microscope 100 and the information processing apparatus 200 are configured integrally with each other, and this structure may be used as an embodiment of the present disclosure. That is, the digital microscope 100 is equipped with a control block such as the CPU and may generate the subject image, the synthesis image, and the like. Further, the digital microscope 100, the information processing apparatus 200, and the viewer 300 may be configured integrally with each other.

In addition to the scaled-up image of the subject which is obtained by the digital microscope, the present disclosure can be applied to a digital image of another kind which is taken by a digital camera or the like.

It should be noted that the present disclosure can take the following configurations.

(1) An information processing apparatus, including:

an obtaining unit configured to obtain a plurality of partial images obtained by taking images with respect to a subject so that a plurality of image-taking areas are overlapped with each other;

a calculation unit configured to determine an area to be used to generate an image of the subject for each of the plurality of partial images obtained and calculate the areas as a plurality of image areas;

a generation unit configured to couple the plurality of image areas calculated with each other to generate the subject image; and

a synthesis unit configured to synthesize an image that indicates a coupling position of the plurality of image areas in the subject image generated with respect to the subject image.

(2) The information processing apparatus according to Item (1), further including

an evaluation unit configured to evaluate reproducibility of the subject on the coupling position, in which

the synthesis unit synthesizes an image on which the reproducibility evaluated is reflected with respect to the subject image.

(3) The information processing apparatus according to Item (2), in which

the evaluation unit evaluates, every two image areas coupled with each other out of the plurality of image areas, the reproducibility of the subject on the coupling position of the two image areas.

(4) The information processing apparatus according to any one of Items (1) to (3), in which

the plurality of partial images each have a connection area, which is an area corresponding to a part where the plurality of image-taking areas are overlapped with each other,

the calculation unit determines an area to be used to generate the subject image by connecting the plurality of partial images with each other with the connection area as a reference, and

the evaluation unit evaluates the reproducibility of the subject on the coupling position on the basis of connection accuracy at a time when the plurality of partial images are connected.

(5) The information processing apparatus according to Item (4), further including:

a connection area image generation unit configured to generate an image of the connection area from the partial image;

an input unit configured to receive an instruction to confirm the subject displayed on the coupling position; and

an output unit configured to output the connection area image generated on the basis of the confirmation instruction received.

(6) The information processing apparatus according to any one of Items (1) to (4), further including:

a storage unit configured to store the plurality of partial image;

an input unit configured to receive an instruction to confirm the subject displayed on the coupling position; and

an output unit configured to output at least one of the plurality of partial images stored on the basis of the confirmation instruction received.

(7) An information processing method in an information processing apparatus, including:

obtaining a plurality of partial images obtained by taking images with respect to a subject so that a plurality of image-taking areas are overlapped with each other;

determining an area to be used to generate an image of the subject for each of the plurality of partial images obtained and calculating the areas as a plurality of image areas;

coupling the plurality of image areas calculated with each other to generate the subject image; and

synthesizing an image that indicates a coupling position of the plurality of image areas in the subject image generated with respect to the subject image.

(8) A program causing an information processing apparatus to execute the steps of:

obtaining a plurality of partial images obtained by taking images with respect to a subject so that a plurality of image-taking areas are overlapped with each other;

determining an area to be used to generate an image of the subject for each of the plurality of partial images obtained and calculating the areas as a plurality of image areas;

coupling the plurality of image areas calculated with each other to generate the subject image; and

synthesizing an image that indicates a coupling position of the plurality of image areas in the subject image generated with respect to the subject image.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processing apparatus, comprising:
an obtaining unit configured to obtain a plurality of partial images obtained by taking images with respect to a subject so that a plurality of image-taking areas are overlapped with each other;
a calculation unit configured to determine an area to be used to generate an image of the subject for each of the plurality of partial images obtained and calculate the areas as a plurality of image areas;
a generation unit configured to couple the plurality of image areas calculated with each other to generate the subject image; and
a synthesis unit configured to synthesize an image that indicates a coupling position of the plurality of image areas in the subject image generated with respect to the subject image.

2. The information processing apparatus according to claim 1, further comprising
an evaluation unit configured to evaluate reproducibility of the subject on the coupling position, wherein
the synthesis unit synthesizes an image on which the reproducibility evaluated is reflected with respect to the subject image.

3. The information processing apparatus according to claim 2, wherein
the evaluation unit evaluates, every two image areas coupled with each other out of the plurality of image areas, the reproducibility of the subject on the coupling position of the two image areas.

4. The information processing apparatus according to claim 1, wherein
the plurality of partial images each have a connection area, which is an area corresponding to a part where the plurality of image-taking areas are overlapped with each other,
the calculation unit determines an area to be used to generate the subject image by connecting the plurality of partial images with each other with the connection area as a reference, and
the evaluation unit evaluates the reproducibility of the subject on the coupling position on the basis of connection accuracy at a time when the plurality of partial images are connected.

5. The information processing apparatus according to claim 4, further comprising:
a connection area image generation unit configured to generate an image of the connection area from the partial image;
an input unit configured to receive an instruction to confirm the subject displayed on the coupling position; and
an output unit configured to output the connection area image generated on the basis of the confirmation instruction received.

6. The information processing apparatus according to claim 1, further comprising:
a storage unit configured to store the plurality of partial image;
an input unit configured to receive an instruction to confirm the subject displayed on the coupling position; and
an output unit configured to output at least one of the plurality of partial images stored on the basis of the confirmation instruction received.

7. An information processing method in an information processing apparatus, comprising:
obtaining a plurality of partial images obtained by taking images with respect to a subject so that a plurality of image-taking areas are overlapped with each other;
determining an area to be used to generate an image of the subject for each of the plurality of partial images obtained and calculating the areas as a plurality of image areas;
coupling the plurality of image areas calculated with each other to generate the subject image; and
synthesizing an image that indicates a coupling position of the plurality of image areas in the subject image generated with respect to the subject image.

8. A program causing an information processing apparatus to execute the steps of:
obtaining a plurality of partial images obtained by taking images with respect to a subject so that a plurality of image-taking areas are overlapped with each other;
determining an area to be used to generate an image of the subject for each of the plurality of partial images obtained and calculating the areas as a plurality of image areas;
coupling the plurality of image areas calculated with each other to generate the subject image; and
synthesizing an image that indicates a coupling position of the plurality of image areas in the subject image generated with respect to the subject image.
